(19) United States
(12) Patent Application Publication
(10) Pub. No.: US 2018/0026242 A1
(43) Pub. Date: Jan. 25, 2018

(54) SECONDARY BATTERY PACK AND VEHICLE COMPRISING THE SAME

(71) Applicant: LG Chem, Ltd., Seoul (KR)

(72) Inventors: Joo Sung LEE, Daejeon (KR); Sun Mi JIN, Daejeon (KR)

(73) Assignee: LG Chem, Ltd., Seoul (KR)

(21) Appl. No.: 15/551,100

(22) PCT Filed: Apr. 22, 2016
(86) PCT No.: PCT/KR2016/004262

§ 371 Date: Aug. 15, 2017

(30) Foreign Application Priority Data
Apr. 22, 2015 (KR) 10-2015-0056374
Apr. 22, 2016 (KR) 10-2016-0049029

(51) Int. Cl. H01M 2/10; H01M 4/66

(52) U.S. Cl. CPC H01M 2/1072; H01M 4/661; B60L 3/0046

(57) ABSTRACT

The present invention relates to a secondary battery pack and a vehicle comprising the same. Specifically, the present invention provides a secondary battery pack comprising at least one battery cell and at least one structure covering at least a part of the battery cell and electrically insulated from the battery cell, wherein at least a part of the structure comprising a material having resistivity of 3 times or less based on resistivity of at least one material comprised in a positive electrode collector of the battery cell.

### FIELD OF THE INVENTION

The present application claims priority to and the benefits of Korean Patent Application No. 10-2015-0056374 filed with the Korean Intellectual Property Office on Apr. 22, 2015, and Korean Patent Application No. 10-2016-0049029 filed with the Korean Intellectual Property Office on Apr. 22, 2016, the entire contents of which are incorporated herein by reference.

The present invention relates to a secondary battery pack and a vehicle comprising the same.

### DESCRIPTION OF THE RELATED ART

With high applicability for various products and electrical properties such as high energy density, secondary batteries have been commonly used not only in mobile devices but in electric vehicles (EV), hybrid vehicles (HV) or the like driven by electrical driving sources.

Such secondary batteries have received attention as a new environmental friendly energy source for improving energy efficiency in terms of producing no by-products from the use of energy as well as a primary advantage of significantly reducing the use of fossil fuel.

Battery packs used in the electric vehicles and the like commonly have a structure comprising an assembly comprised a plurality of unit cells.

One of the most important problems on such secondary batteries recently standing out is to secure safety. Not securing safety of secondary batteries may lead to accidents such as electric shocks, fires or explosions not to mention of secondary battery damage, which may cause casualties and property damage.

Cases of secondary battery stability being threatened may comprise penetration by acute needle-shaped materials or explosion during safety tests such as penetration tests of secondary batteries.

In order to prevent ignition caused by collision destruction in the related art, lithium secondary batteries comprising an electrode assembly fabricated by winding a first electrode plate, a second electrode plate and a separator provided between the first electrode plate and the second electrode plate, and a can accommodating the electrode assembly, wherein the separator is formed with materials comprised ceramics, polarity of the first electrode plate is formed opposite to polarity of the can, and an outermost part of the first electrode plate is disposed outside an outermost part of the second electrode plate have been proposed.

However, new approaches have been required as secondary batteries having such a structure have increased sizes and increased energy density, and safety is difficult to be fundamentally secured even with this method.

Accordingly, development of secondary batteries having enhanced safety by fundamentally blocking risks of explosion when the secondary batteries are collided and destroyed has been required.

### PRIOR DOCUMENT

Korean Patent Number 10-0876268.

### DISCLOSURE OF THE INVENTION

### Technical Problem

In view of the above, the present invention provides a secondary battery pack having enhanced safety from risks such as explosion.

The present invention also provides a vehicle comprising the secondary battery pack as a power supply.

### Technical Solution

One embodiment of the present invention provides a secondary battery pack comprising at least one battery cell and at least one structure covering at least a part of the battery cells and electrically insulated from the battery cell, wherein at least a part of the structure comprises a material having resistivity of 3 times or less based on resistivity of at least one material comprising in a positive electrode collector of the battery cell.

Specifically, one embodiment of the present invention provides a secondary battery pack comprising

a housing, at least one Partition wall spatially separating the interior of the housing, at least one electrode cell accommodated between the Partition walls in the interior of the housing, and an electrolyte accommodated in the interior of the housing,

wherein the electrode cell comprises a positive electrode comprising a positive electrode active material coated on a positive electrode collector, a negative electrode comprising a negative electrode active material coated on a negative electrode collector, and a separator located between the positive electrode and the negative electrode to electrically separate the positive electrode and the negative electrode, and

at least a part of the housing and the Partition wall comprises a material having resistivity of 3 times or less based on resistivity of materials comprising in the positive electrode collector.

More specifically, one embodiment of the present invention provides a secondary battery pack including

a housing, at least one Partition wall spatially separating the interior of the housing, at least one electrode cell accommodated between the Partition walls in the interior of the housing, and an electrolyte accommodated in the interior of the housing,

wherein the electrode cell comprises a positive electrode comprising a positive electrode active material coated on a positive electrode collector, a negative electrode comprising a negative electrode active material coated on a negative electrode collector, and a separator located between the positive electrode and the negative electrode to electrically separate the positive electrode and the negative electrode, and

at least a part of the housing comprises a material having resistivity of 3 times or less based on resistivity of materials comprised in the positive electrode collector.

Another embodiment of the present invention provides a vehicle comprising the secondary battery pack as a power supply.

### Advantageous Effects

A secondary battery pack according to the present invention uses materials having an equal level of resistivity with a positive electrode collector as a structure covering a battery cell. Accordingly, when the secondary battery pack is collided and destroyed, and the structure and the positive electrode collector are brought into contact with each other, the structure performs a role of a conductive path through which a current may flow instead of the positive electrode collector, and as a result, ignition caused by the contact between the positive electrode collector and a negative electrode active material can be prevented. Furthermore, by using the secondary battery pack in vehicles, high stability can be secured.

### DESCRIPTION OF DRAWINGS

FIG. 1 is a mimetic diagram illustrating one example of a secondary battery pack of the present invention.

FIG. 2 is a mimetic diagram illustrating one example of a battery cell of the present invention.

FIG. 3 is (a) a mimetic diagram illustrating one example of a secondary battery pack of the present invention, and (b) a mimetic diagram illustrating one example of a secondary battery pack of the present invention being destroyed.

### REFERENCE NUMERAL

1, 410: Positive Electrode
2, 430: Separator
3, 420: Negative Electrode
10: Battery Cell
20: Partition wall
30, 440: Housing
100: Secondary Battery Pack

### MODE FOR CARRYING OUT THE INVENTION

Hereinafter, the present invention will be described in more detail in order to illuminate the present disclosure.

Terms or words used in the present specification and the claims are not to be interpreted limitedly to common or dictionary definitions, and shall be interpreted as meanings and concepts corresponding to technological ideas of the present invention based on a principle in which the inventors may suitably define the concepts of terms in order to describe the invention in the best possible way.

Terms used in the present specification are used for describing illustrative examples, and are not intended to limit the present invention. Expression of singular forms includes expression of plural forms unless clearly meant otherwise in the context.

In the present specification, terms such as “comprise”, “provide” or “have” need to be understood as designation of the presence of worked characteristics, numbers, steps, constituents or combinations thereof, and not to exclude possibility of presence or addition of one or more other characteristics, numbers, steps, constituents or combinations thereof in advance.

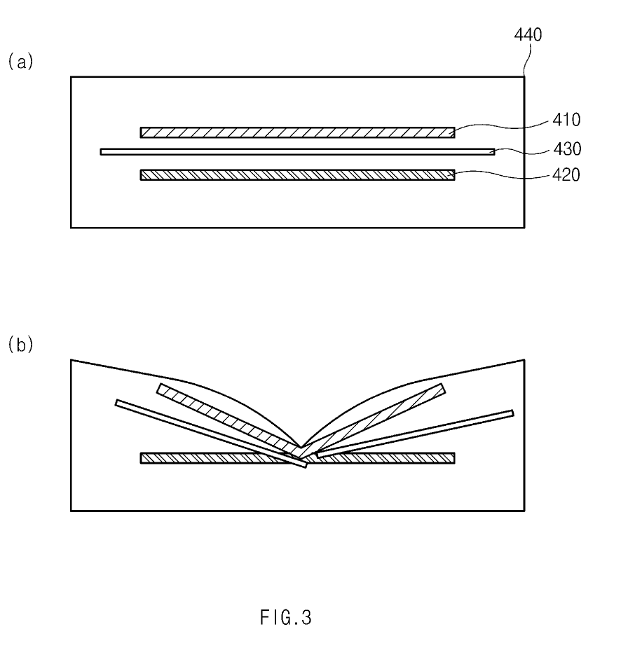

First, when referring to FIG. 3(a), an existing secondary battery pack comprises at least one electrode cell comprising a positive electrode (410) comprising a positive electrode active material on a positive electrode collector, a negative electrode (420) comprising a negative electrode active material coated on a negative electrode collector, a separator (430) located between the positive electrode and the negative electrode to electrically separate the positive electrode and the negative electrode, and a housing (440) accommodating the battery cells, and charge and discharge is possible by an electrochemical reaction between the constituents.

Meanwhile, as materials of housing and Partition wall of existing secondary batteries, iron (9.68 μΩ·cm) having higher resistivity compared to aluminum (2.73 μΩ·cm) that is normally used as a positive electrode collector is normally used. Accordingly, as shown in FIG. 3(b), destruction of a secondary battery pack comprising battery cells and a housing may cause various heating and ignition.

Causes of the heating may comprise 1) a contact between a positive electrode collector and a negative electrode collector, 2) a contact between a positive electrode collector and a negative electrode active material, 3) a contact between a positive electrode active material and a negative electrode collector, and 4) a contact between a positive electrode active material and a negative electrode active material. Among these, as much current flows into a positive electrode collector, 2) a contact between a positive electrode collector and a negative electrode active material is particularly dangerous in terms of exothermicity.

In order to prevent such ignition from collision destruction of secondary batteries, methods of using separators comprising ceramics, and the like, have been proposed in the art. However, with this method, new approaches are further required as sizes and energy density of secondary batteries increase, and safety is difficult to be fundamentally secured.

In view of the above, the present invention provides a secondary battery pack having enhanced stability by using a material capable of performing a role of a conductive path through which a current may flow instead of a positive electrode collector in a structure such as a housing covering the battery cells, in order to prevent increased risks of heating and ignition occurring when the positive electrode collector and the negative electrode active material are brought into contact with each other during the destruction of the secondary battery.

Specifically, one embodiment of the present invention provides a secondary battery pack comprising at least one battery cell, and at least one structure covering at least a part of the battery cell and electrically insulated from the battery cell, wherein at least a part of the structure comprises a material having resistivity of 3 times or less based on resistivity of at least one material comprising in the positive electrode collector.

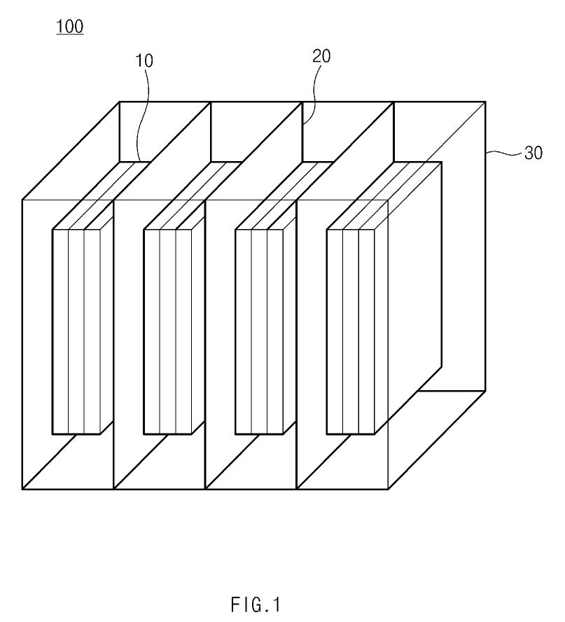

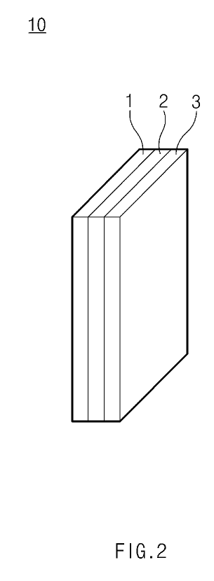

Hereinafter, the present invention will be described in detail with reference to FIGS. 1 and 2 according to embodiments, however, the scope of the present invention is not limited thereto.

When referring to FIG. 1, one embodiment of the present invention provides a secondary battery pack (100) comprising at least one battery cell (10) and at least one structure covering at least a part of the battery cell and electrically insulated from the battery cells.

The battery cells (10) comprise a positive electrode (1) comprising a positive electrode active material coated on a positive electrode collector, a separator (2), a negative electrode (3) comprising a negative electrode active material coated on a negative electrode collector, an electrolyte (not shown) and the like, and charge and discharge is possible by an electrochemical reaction between the constituents (refer to FIG. 2).

Herein, the positive electrode collector may comprise aluminum, or further comprise at least one metal selected from the group consisting of copper, nickel, iron, stainless steel and titanium, the metal is coated on the aluminum.

In addition, the structure may be at least one selected from the group consisting of a housing (30) accommodating at least one battery cell (10); and a Partition wall (20) separating the battery cells (10), and besides, may comprise all structures in the interior of a secondary battery pack locating nearest the battery cells (10) and covering part of the battery cells (10).

At least a part of the structure may use a material having resistivity of 3 times or less, specifically 0.5 times to 1 time, based on resistivity of materials comprising in the positive electrode collector or at least one material coated on the positive electrode collector so that the structure is capable of performing a conductive path through which a current may flow instead of the positive electrode collector.

Herein, when resistivity of the structure is greater than 3 times based on materials comprising in the positive electrode collector, the structure resistivity is too high compared to the positive electrode collector resistivity, and when a secondary battery pack is destroyed, a current of the positive electrode collector may not be transferred to the structure to cause to a problem of heating and ignition of the battery pack.

Meanwhile, in the secondary battery pack of the present invention, at least a part of the structure comprises a material having resistivity of 3 times or less, specifically 0.5 times to less than 1 time based on materials comprised in the positive electrode collector, and therefore, a current of the positive electrode collector may be more readily taken since the structure has higher electrical conductivity compared to materials comprising in the positive electrode collector, and as a result, an excellent effect of preventing ignition of the secondary battery may be accomplished.

In the secondary battery pack of the present invention, at least a part of the structure may comprise, for example, at least one material selected from the group consisting of silver, copper, gold, aluminum, tungsten, zinc, brass and nickel, and specifically at least one material selected from the group consisting of silver, copper, gold and aluminum, or may comprise stainless steel/coating layer by coating at least one material selected from the group consisting of silver, copper, gold, aluminum, tungsten, zinc, brass and nickel, specifically at least one material selected from the group consisting of silver, copper, gold and aluminum on a surface of stainless steel.

As described above, the structure comprising a stainless steel/coating layer may reduce risks of ignition by the coating layer first in contact with the positive electrode collector when a battery is destroyed works as a conductive path through which a current may flow instead of the positive electrode collector.

As one example, the positive electrode collector may use aluminum having resistivity of 2.73 μΩ·cm, and the structure may comprise at least one material selected from the group consisting of silver (1.62 μΩ·cm), copper (1.72 μΩ·cm), gold (2.4 μΩ·cm), aluminum (2.73 μΩ·cm), tungsten (5.5 μΩ·cm), zinc (5.9 μΩ·cm), brass (5 to 7 μΩ·cm) and nickel (7.24 μΩ·cm), specifically at least one material selected from the group consisting of silver (1.62 μΩ·cm), copper (1.72 μΩ·cm), gold (2.4 μΩ·cm) and aluminum (2.73 μΩ·cm), or may comprise a form in which the material is coated on stainless steel.

Specifically, when the structure is a housing, using silver having resistivity of approximately ½ of aluminum as a material comprised in the housing may further enhance stability since much current is taken by the silver.

In addition, resistivity of the material comprised in at least a part of the structure is from 1 μΩ·cm to 8 μΩ·cm and specifically from 1 μΩ·cm to 3 μΩ·cm, but is not limited thereto, and materials having resistivity of 3 times or less may be properly selected and used depending on the types of the positive electrode collector.

When the positive electrode collector is coated with other materials instead of having a single composition, a cause of heating occurring from a contact with a negative electrode active material is in the coated material, an outermost part of the positive electrode collector. For providing a conductive path through which a current may flow instead of the positive electrode collector, materials having resistivity of 3 times or less, specifically having an equal level of resistivity compared to materials comprised in the positive electrode collector, need to be used as the material of the structure.

Herein, when the positive electrode collector is coated with other materials, the structure may use materials having resistivity of 0.5 times to less than 1 time based on resistivity of the materials coated on the positive electrode collector.

Specifically, one embodiment of the present invention provides a secondary battery pack comprising a housing, at least one Partition wall spatially separating the interior of the housing, at least one electrode cell accommodated between the Partition walls in the interior of the housing, and an electrolyte accommodated in the interior of the housing, wherein the electrode cells comprises a positive electrode comprising a positive electrode active material coated on a positive electrode collector, a negative electrode comprising a negative electrode active material coated on a negative electrode collector, and a separator located between the positive electrode and the negative electrode to electrically separate the positive electrode and the negative electrode, and at least a part of the housing and the Partition walls comprises a material having resistivity of 3 times or less based on resistivity of materials comprised in the positive electrode collector.

More specifically, one embodiment of the present invention provides a secondary battery pack comprising a housing, at least one Partition wall spatially separating the interior of the housing, at least one electrode cell accommodated between the Partition walls in the interior of the housing, and an electrolyte accommodated in the interior of the housing, wherein the electrode cell comprises a positive electrode comprising a positive electrode active material coated on a positive electrode collector, a negative electrode comprising a negative electrode active material coated on a negative electrode collector, and a separator located between the positive electrode and the negative electrode to electrically separate the positive electrode and the negative electrode, and at least a part of the housing comprises a material having resistivity of 3 times or less based on resistivity of materials forming the positive electrode collector.

In other words, the housing (30) fixes and accommodates at least one battery cell (10) to fabricate a high-capacity battery pack, and is capable of protecting the battery cells (10) from the outside. The housing (30) may have a form surrounding all of the battery cells (10), or have a form surrounding only part of the battery cells (10).

In addition, the Partition wall (20) prevents an electrical contact between the battery cells (10) by separating the battery cells (10), and performs a role of radiating heat generated when operating a battery. The Partition wall (20) may be located in a front part between the cells (10) of the battery, or may also be located only in an edge part of the battery cell (10) to perform a role of separating the cells (10) of the battery.

The housing and the Partition walls are located nearest to the battery cell (10), and accordingly, may be brought into contact with a positive electrode collector when a secondary battery pack (100) is destroyed, and become a conductive path taking a current that may flow to the positive electrode collector, and consequently, may prevent heating and ignition caused by the contact of the positive electrode collector and a negative electrode active material.

Herein, at least a part of the structure may be a part facing a front part of the battery cell (10). By using a constitution of coating only the front part of the battery cell (10), a part having highest probability of being in contact with the positive electrode collector (a part occupying the largest area in the battery cell) when a secondary battery is destroyed, with a material having an equal level of resistivity compared to materials comprising in the positive electrode collector, only the part facing the front part of the battery cell (10) is coated with the material of the present invention while using components of the housing (30) or the Partition wall (20) used in the art, and by coating only a part as described above, an advantageous effect is obtained in terms of costs.

As one example, in a secondary battery pack (100) having battery cells (10) in which a separator (2) is located between a sheet-type positive electrode (1) and a negative electrode (3), wherein the battery cells (10) are laminated in a direction of one battery cell positive electrode (1) facing another battery cell negative electrode (3), and a housing (30) or a Partition wall (20) covers the laminated battery cells (10), the housing (30) or the Partition wall (20) part locating in the part facing a front part of the battery cell (10) locating at an outermost side of the laminated battery cells (10) may use materials having an equal level of resistivity compared to materials of the positive electrode collector.

As described above, the present invention uses materials having an equal level of resistivity compared to the positive electrode collector as the structure of the housing and the like covering the battery cells in order to prevent increased risks of heating and ignition occurring when the positive electrode collector and a negative electrode active material are brought in contact with each other during the destruction of the secondary battery, and accordingly, the structure performs a role of a conductive path through which a current may flow instead of the positive electrode collector, and safety may be enhanced by controlling exothermicity.

Meanwhile, the secondary battery pack according to one embodiment of the present invention may be a lithium secondary battery pack, and a general lithium secondary battery cell may comprise a positive electrode, a negative electrode, a separator and a lithium salt-containing non-aqueous electrolyte.

In the battery cell, the positive electrode may be, for example, prepared by coating a mixture of a positive electrode active material, a conductor and a binder on a positive electrode collector, and then drying the result, and as necessary, a filler may be further added to the mixture.

The positive electrode active material may comprise layer compounds such as lithium cobalt oxide (LiCoO₂) or lithium nickel oxide (LiNiO₂) or compounds substituted with at least one transition metal; lithium manganese oxides (LiMnO₂) such as a chemical formula of Li₁₊ₓMn₂₋ₓO₄ (herein, x is from 0 to 0.33), LiMnO₃, LiMn₂O₃ and LiMnO₂; lithium copper oxides (Li₂CuO₂); vanadium oxides such as LiV₃O₈, LiFe₃O₄, V₂O₅ and Cu₂V₂O₇; lithiated nickel oxides represented by a chemical formula of LiNi₁₋ₓMₓO₂ (herein, M is Co, Mn, Al, Cu, Fe, Mg, B or Ga, and x is from 0.01 to 0.3); lithium manganese complex oxides represented by a chemical formula of LiMn₂₋ₓMₓO₂ (herein, M is Co, Ni, Fe, Cr, Zn or Ta, and x is from 0.01 to 0.1) or Li₂Mn₃MO₈ (herein, M is Fe, Co, Ni, Cu or Zn); LiMn₂O₄ in which some of lithium in the chemical formula are substituted with alkali earth metals; disulfide compounds; Fe₂(MoO₄)₃ and the like, but the material is not limited thereto.

The conductor is normally comprised in 1% by weight to 30% by weight based on the total weight of the mixture comprising the positive electrode active material. Such a conductor is not particularly limited as long as it has conductivity without inducing chemical changes in the corresponding battery, and examples thereof may comprise graphite such as natural graphite or artificial graphite; carbon black such as acetylene black, Ketjen black, channel black, furnace black, lamp black or thermal black; conductive fiber such as carbon fiber or metal fiber; metal powder such as fluorocarbon, aluminum or nickel powder; conductive whiskers such as zinc oxide or potassium titanate; conductive oxides such as titanium oxide; conductive materials such as polyphenylene derivatives, and the like.

The binder is a component assisting binding of the active material, the conductor and the like, and binding for the collector, and normally added in 1% by weight to 30% by weight based on the total weight of the mixture including the positive electrode active material. Examples of such a binder may comprise polyvinylidene fluoride, polyvinyl alcohol, carboxymethylcellulose (CMC), starch, hydroxypropylcellulose, regenerated cellulose, polyvinylpyrrolidone, tetrafluoroethylene, polyethylene, polypropylene, an ethylene-propylene-diene terpolymer (EPDM), a sulfonated EPDM, styrene-butadiene rubber, fluorine rubber, various copolymers and the like.

The filler is a component suppressing expansion of the positive electrode, which may be used as necessary, and is not particularly limited as long as it is a fibrous material that does not induce chemical changes in the corresponding battery, and examples thereof may comprise olefin-based polymers such as polyethylene or polypropylene; or a fibrous material such as glass fiber or carbon fiber.

The negative electrode is prepared by coating a negative electrode active material on a negative electrode collector, and drying the result, and as necessary, components described above may be selectively further comprised.

Examples of the negative electrode active material may use carbon such as hard carbon and graphite-based carbon; metal complex oxides such as LiₓFe₂O₃ (0≦x≦1), LiₓWO₂ (0≦x≦1), SnₓMe₁₋ₓMe′_{y}O_{z} (Me: Mn, Fe, Pb, Ge; Me′: Al, B, P, Si, elements of groups 1, 2 and 3 in the periodic table, halogen; 0<x≦1; 1≦y≦3; 1≦z≦8); lithium metal; lithium alloys; silicon-based alloys; tin-based alloys; metal oxides such as SnO, SnO₂, SnO₂, PbO, PbO₂, Pb₂O₃, Pb₃O₄, Sb₂O₃, Sb₂O₄, Sb₂O₅, GeO, GeO₂, Bi₂O₃, Bi₂O₄ and Bi₂O₅; conductive polymers such as polyacetylene; Li—Co—Ni-based materials and the like.

The separator is provided between the positive electrode and the negative electrode, and uses an insulting thin film having high ion permeability and mechanical strength. A pore diameter of the separator is generally from 0.01 μm to 10 μm, and a thickness thereof is generally from 5 μm to 300 μm. Examples of such a separator may comprise hydrophobic olefin-based polymers having chemical resistance such as polypropylene; sheets, non-woven fabrics or the like made of glass fiber, polyethylene or the like. When using a solid electrolyte such as polymers, the solid electrolyte may also serve as the separator.

The lithium salt-containing non-aqueous electrolyte is formed with a polar organic electrolyte and a lithium salt. As the electrolyte, a non-aqueous liquid electrolyte, an organic solid electrolyte, an inorganic solid electrolyte and the like may be used.

Examples of the non-aqueous liquid electrolyte may comprise an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxyethane, tetrahydroxy franc, 2-methyl tetrahydrofuran, dimethyl sulfoxide, 1,3-dioxolane, formamide, dimethylformamide, dioxolane, acetonitrile, nitromethane, methyl formate, methyl acetate, triester phosphate, trimethoxymethane, dioxolane derivatives, sulfolane, methyl sulfolane, 1,3-dimethyl-2-imidazolidinone, propylene carbonate derivatives, tetrahydrofuran derivatives, ether, methyl propionate and ethyl propionate.

Examples of the organic solid electrolyte may comprise polyethylene derivatives, polyethylene oxide derivatives, polypropylene oxide derivatives, phosphate ester polymers, poly agitation lysine, polyester sulfide, polyvinyl alcohol, polyvinylidene fluoride, polymers including ionic dissociation groups, and the like.

Examples of the inorganic solid electrolyte may comprise nitrides, halides, sulfates and the like of Li such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH and Li₃PO₄—Li₂S—SiS₂.

The lithium salt is a material favorably dissolved in the non-aqueous electrolyte, and examples thereof may comprise LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, lower aliphatic carboxylic acid lithium, 4-phenyl lithium borate, imide and the like.

In addition, for improving charge and discharge properties, flame retardancy and the like, compounds such as pyridine, triethyl phosphite, triethanolamine, cyclic ether, ethylenediamine, n-glyme, hexaphosphate triamide, nitrobenzene derivatives, sulfur, quinone imine dyes, N-substituted oxazolidinone, N,N-substituted imidazolidine, ethylene glycol dialkyl ethers, ammonium salts, pyrrole, 2-methoxyethanol and aluminum trichloride may be added to the non-aqueous electrolyte solution. In some cases, in order to provide nonflammability, halogen-containing solvents such as carbon tetrachloride and trifluoroethylene may be further comprised, and carbon dioxide gas may be further comprised for enhancing a high temperature storage property.

In addition, another embodiment of the present invention provides a vehicle including the secondary battery pack (100) as a power supply.

The secondary battery pack (100) uses a material having an equal level of resistivity compared to a positive electrode collector in a structure covering battery cells (10), and accordingly, is capable of preventing risks of explosion caused by heating and ignition even when the secondary battery pack (100) having a large size and high energy density used in vehicles is destroyed.

Herein, the vehicles may be electric vehicles, hybrid electric vehicles or plug-in hybrid vehicles.

Hereinafter, the present invention will be described in detail with reference to examples so that a person skilled in the art may readily implement the invention. However, the present invention may be implemented to various different forms and is not limited to the examples described herein.

### EXAMPLE

### Example 1

Positive electrode slurry was prepared by adding 89% by weight of a LiCoO₂ mixture as a positive electrode active material, 8% by weight of carbon black as a conductor and 3% by weight of polyvinylidene fluoride (PVdF) as a binder to N-methyl-2-pyrrolidone (NMP), a solvent. The positive electrode mixture slurry was applied on an aluminum (Al) thin film, a positive electrode collector, having a thickness of approximately 20 μm, and the result was dried and then roll pressed to prepare a positive electrode.

In addition, negative electrode mixture slurry was prepared by adding 97% by weight of graphite-based powder as a negative electrode active material, 2% by weight of PVdF as a binder and 1% by weight of carbon black as a conductor to NMP, a solvent. The negative electrode mixture slurry was applied on a copper (Cu) thin film, a negative electrode collector, having a thickness of 10 μm, and the result was dried and then roll pressed to prepare a negative electrode.

A battery cell was prepared by inserting an electrode assembly comprising the positive electrode and the negative electrode prepared as above, and a polyolefin separator to a battery case.

Then, the battery cell was accommodated in a housing comprising aluminum (2.73 μΩ·cm) to fabricating a secondary battery pack.

### Example 2

A secondary battery pack was fabricated in the same manner as in Example 1 except that a housing comprising silver (1.62 μΩ·cm) was used instead of the housing comprising aluminum.

### Example 3

A secondary battery pack was fabricated in the same manner as in Example 1 except that a housing coating copper (1.72 μΩ·cm) on a stainless steel surface was used instead of the housing comprising aluminum.

### Comparative Example 1

A secondary battery pack was fabricated in the same manner as in Example 1 except that a housing formed with iron (9.68 μΩ·cm) was used instead of the housing comprising aluminum.

### TEST EXAMPLE

### Test Example 1

### Nail Penetration Test

The secondary battery packs fabricated in Examples 1 to 3 and Comparative Example 1 were prepared in a fully charged state. Using a nail penetration tester, tests penetrating the center of each of the secondary battery packs fabricated in Examples 1 to 3 and Comparative Example 1 with a nail having a diameter of 3.0 mm made of aluminum (Test 1) and a nail having a diameter of 3.0 mm made of iron (Test 2) were conducted. The penetration rate was 5 cm per second. Results showing the status of ignition are shown in Table 1.

TABLE 1

| | | | | Comparative |
|---|---|---|---|---|
| | Example 1 | Example 2 | Example 3 | Example 1 |
| Housing | Aluminum | Silver | Stainless | Iron |
| Material | | | Steel/Copper | |
| Test 1 | Not Ignited | Not Ignited | Not Ignited | Ignited |
| Test 2 | Ignited | Not Ignited | Not Ignited | Ignited |

As shown in Table 1, it was identified that the secondary battery packs of Examples 2 and 3 comprising a housing comprised materials having resistivity lower than the secondary battery collector material did not ignite in both Tests 1 and 2 since the housing performed a role of a conductive path through which a current may flow instead of the positive electrode collector.

Meanwhile, it was seen that the secondary battery pack of Comparative Example 1 comprising a housing comprised iron having resistivity higher than the secondary battery collector material ignited in both Tests 1 and 2.

Meanwhile, it was seen that the secondary battery pack of Example 1 including a housing formed with aluminum having the same resistivity as the secondary battery collector material did not ignite in Test 1 using an aluminum nail, while being ignited in Test 1 using an iron nail.

From such results, it was seen that, when aluminum was used as the positive electrode collector and the collector was brought into contact with a nail made of aluminum having the same resistivity in the penetration test, ignition that may occur by the positive electrode collector and the negative electrode active material being in contact with each other did not occur since the nail took a current, whereas, when the collector was in contact with a nail made of iron, ignition occurred by the positive electrode collector and the negative electrode active material since a current did not flow to iron having higher resistivity.

Hereinbefore, preferred embodiments of the present invention have been described in detail, however, the scope of the present invention is not limited thereto, and various modifications and improvements made by a person skilled in the art using the basic concept of the present invention defined in the claims also belong to the scope of the present invention.

1. A secondary battery pack comprising:
at least one battery cell; and
at least one structure covering at least a part of the battery cell and electrically insulated from the battery cell,
wherein at least a part of the structure comprises a material having resistivity of 3 times or less based on resistivity of at least one material comprised in a positive electrode collector of the battery cell.

2. The secondary battery pack of claim 1, wherein the positive electrode collector comprises aluminum.

3. The secondary battery pack of claim 2, wherein the positive electrode collector further comprises at least one metal selected from the group consisting of copper, nickel, iron, stainless steel and titanium, and the metal is coated on the aluminum.

4. The secondary battery pack of claim 1, wherein the structure is at least one selected from the group consisting of a housing accommodating at least one battery cell and a Partition wall separating the battery cells.

5. The secondary battery pack of claim 1, wherein at least a part of the structure is a part facing a front part of the battery cell.

6. The secondary battery pack of claim 1, wherein at least a part of the structure comprises a material having resistivity of 0.5 times to 1 time based on resistivity of at least one material comprised in the positive electrode collector of the battery cell.

7. The secondary battery pack of claim 1, wherein resistivity of the material comprised in at least a part of the structure is from 1 μΩ·cm to 8 μΩ·cm.

8. The secondary battery pack of claim 7, wherein resistivity of the material comprised in at least a part of the structure is from 1 μΩ·cm to 3 μΩ·cm.

9. The secondary battery pack of claim 1, wherein the material comprised in at least a part of the structure is at least one selected from the group consisting of silver, copper, gold, aluminum, tungsten, zinc, brass and nickel.

10. The secondary battery pack of claim 9, wherein the material comprised in at least a part of the structure is at least one selected from the group consisting of silver, copper, gold and aluminum.

11. The secondary battery pack of claim 1, wherein the material comprised in at least a part of the structure is a material coated at least one material selected from the group consisting of silver, copper, gold, aluminum, tungsten, zinc, brass and nickel on stainless steel.

12. The secondary battery pack of claim 11, wherein the material comprised in at least a part of the structure is a material coated at least one material selected from the group consisting of silver, copper, gold and aluminum on stainless steel.

13. A secondary battery pack comprising:
a housing;
at least one Partition wall spatially separating the interior of the housing;
at least one battery cell accommodated between the Partition walls in the interior of the housing; and
an electrolyte accommodated in the interior of the housing,
wherein the battery cell comprises a positive electrode comprising a positive electrode active material coated on a positive electrode collector, a negative electrode comprising a negative electrode active material coated on a negative electrode collector, and a separator located between the positive electrode and the negative electrode to electrically separate the positive electrode and the negative electrode; and
at least a part of at least one selected from the group consisting of the housing and the Partition wall comprises a material having resistivity of 3 times or less based on resistivity of materials comprised in the positive electrode collector.

14. (canceled)

15. The secondary battery pack of claim 13, wherein the positive electrode collector comprises aluminum.

16. The secondary battery pack of claim 13, wherein the positive electrode collector further comprises at least one metal selected from the group consisting of copper, nickel, iron, stainless steel and titanium, and the metal is coated on the aluminum.

17. The secondary battery pack of claim 13, wherein at least a part of one of at least one selected from the group consisting of the housing and the Partition wall comprises a material having resistivity of 0.5 times to 1 time compared to resistivity of at least one material comprised in the positive electrode collector.

18. The secondary battery pack of claim 13, wherein resistivity of the material comprised in at least a part of at least one selected from the group consisting the housing and the Partition wall is from 1 μΩ·cm to 8 μΩ·cm.

19. (canceled)

20. The secondary battery pack of claim 13, wherein the material comprised in at least a part of at least one selected from the group consisting of the housing and the Partition wall is at least one selected from the group consisting of silver, copper, gold, aluminum, tungsten, zinc, brass and nickel.

21. (canceled)

22. The secondary battery pack of claim 13, wherein the material comprised in at least a part of at least one selected from the group consisting of the housing and the Partition wall is a material coated at least one material selected from the group consisting of silver, copper, gold, aluminum, tungsten, zinc, brass and nickel on stainless steel.

23. The secondary battery pack of claim 13, wherein the material comprised in at least a part of at least one selected from the group consisting of the housing and the Partition wall is a material coated at least one material selected from the group consisting of silver, copper, gold and aluminum on stainless steel.

24. (canceled)
